(19) United States
(12) Patent Application Publication
(10) Pub. No.: US 2026/0268336 A1
(43) Pub. Date: Sep. 10, 2026

(54) SYSTEM AND METHOD FOR ENHANCING INDUSTRIAL FINAL ASSEMBLY QUALITY

(71) Applicant: Wayne State University, Detroit, MI (US)

(72) Inventors: Sujeet Shrestha, Chelsea, MI (US); Ratna Babu Chinnam, Rochester, MI (US)

(21) Appl. No.: 19/557,357

(22) Filed: Mar. 5, 2026

Related U.S. Application Data
(60) Provisional application No. 63/767,715, filed on Mar. 6, 2025.

(51) Int. Cl. G06Q 30/012

(52) U.S. Cl. CPC G06Q 30/012

(57) ABSTRACT

A system for predictive warranty claims detection in a multi-station product assembly process includes a plurality of sensors disposed at multiple assembly stations. A network receives and stores the sensor data in association with product identifiers and assembly station identifiers. A computing device in communication with the network includes at least one processor and a memory storing instructions that, when executed, cause the computing device to provide the sensor data as sequential input to a trained deep learning neural network, analyze the sequential sensor data to detect deviations from normal sensor readings indicative of early defect patterns, and generate, before completion of a given product, an output indicative of a likelihood that the given vehicle will lead to a warranty claim. The system may employ transfer learning to accelerate deployment on new product platforms and reduce early launch quality issues.

### CROSS-REFERENCE TO RELATED APPLICATIONS

This application claims the benefit of priority to U.S. Provisional Patent Application No. 63/767,715, filed on Mar. 6, 2025, entitled “Predictive Warranty Claims and Cross-Station Interaction Detection System for Automotive Final Assembly,” the contents of which is hereby incorporated by reference in its entirety.

### TECHNICAL FIELD

The present disclosure relates generally to quality control in multi-station industrial assembly processes and, more particularly, to a system and method for enhancing multi-station product (e.g., automotive, electrical equipment, aerospace, machines, medical devices, etc.) final assembly quality using sensor-based monitoring and machine-learning models to detect early defect patterns and predict warranty-related outcomes.

### BACKGROUND

Industrial assembly and manufacturing (e.g., automotive, aerospace, electronics, medical devices, etc.) faces significant challenges with warranty claims and recalls, costing manufacturers billions annually. Many of these claims arise from defects in the final assembly process, which are difficult to detect using traditional quality control methods. As machines and electrical components become more complex, interactions between various assembly stages create a challenge in identifying root causes of defects. Most current systems focus on detecting issues at individual stations without considering cumulative effects across the assembly line. As a result, quality issues that span multiple stations often go unnoticed.

In the automotive industry, the final assembly process is a critical stage where various components and systems are brought together to create a fully functional vehicle. This process involves multiple stations, each responsible for assembling different parts of the vehicle. Ensuring the quality and reliability of the final product is paramount, as any defects or issues that arise from postproduction can lead to costly warranty claims and damage to the manufacturer's reputation. Traditional methods of quality control often rely on postproduction inspections and reactive measures, which may not effectively prevent issues from reaching the consumer.

Moreover, current quality control and management processes heavily rely on station task/process tolerance specifications set by designers, often in isolation, without access to a detailed and accurate understanding for how the products are being used by customers. The automotive plants also rely on go/no-go type testing within stations and at the end of the assembly lines to detect defects. However, these tests and tolerances do not fully account for the real-world conditions under which the products are used by customers.

The integration of machine learning and data analytics into the assembly process offers a promising avenue for enhancing quality assurance. By leveraging data collected from various stations along the assembly line, manufacturers can gain predictive insights into potential quality issues before they manifest in the final product. This proactive approach not only helps in reducing warranty claims but also improves the overall efficiency of the assembly process. The challenge lies in effectively integrating and analyzing the vast amounts of data generated during production to provide actionable insights that can be used to optimize the assembly process and improve product quality.

This disclosure addresses these limitations by using Industrial Internet of Things (IIoT) driven data and machine learning to predict defects early and to identify critical process interactions across stations that contribute to quality defects. This enhances detection accuracy and operational efficiency while reducing warranty costs. The proposed system connects IIoT data with early field warranty claims to enhance quality control and management right within the assembly plant. In addition, the disclosure proposes an approach for optimizing tolerances using IIoT data combined with early warranty claims data.

### BRIEF DESCRIPTION OF THE DRAWINGS

While the claims are not limited to a specific illustration, an appreciation of the various aspects is best gained through a discussion of various examples thereof. Although the drawings represent illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrates are described in detail by referring to the drawings as follows:

FIG. 1 illustrates a block diagram of an embodiment of a system for enhancing automotive final assembly quality using predictive warranty claims detection and cross-station interaction analysis according to the disclosure.

FIG. 2 illustrates a flowchart of an embodiment of a data collection, preprocessing, feature selection, modeling, and prediction process for identifying products (e.g., vehicles) likely to lead to warranty claims according to the disclosure.

FIG. 3 illustrates a flowchart of an embodiment of a feature selection process based on F1-score changes for identifying important multi-station sensor features according to the disclosure.

FIGS. 4A and 4B illustrate flowcharts of an embodiment of a feature selection procedure, including initialization, F1-score calculation, normalization of feature contributions, ranking, and selection of features based on a contribution threshold according to the disclosure.

FIGS. 5A and 5B illustrate flowcharts of an embodiment of a predictive warranty claims model training and evaluation process using sensor data and historical warranty claims according to the disclosure.

FIG. 6 illustrates a block diagram of an embodiment of a cross-station interaction detection system for analyzing dependencies between assembly stations in an automotive final assembly process according to the disclosure.

FIGS. 7A and 7B illustrate flowcharts of an embodiment of a process tolerance adjustment optimization framework for multi-station sensor-based warranty claim detection according to the disclosure.

FIGS. 8A and 8B illustrate flowcharts of an embodiment of a feature selection process for the cross-station interaction detection system using F1 score changes, including normalization, ranking, and selection of features based on cumulative contribution according to the disclosure.

FIG. 9 illustrates a high-level block diagram of a representative computing device used for implementing various features of the disclosure according to the disclosure.

### DETAILED DESCRIPTION

In the drawings, where like numerals and characters indicate like or corresponding parts throughout the several views, exemplary illustrations are shown in detail. The various features of the exemplary approaches illustrated and described with reference to any one of the figures may be combined with features illustrated in one or more other figures, as it will be understood that alternative illustrations that may not be explicitly illustrated or described may be able to be produced. The combinations of features illustrated provide representative approaches for typical applications. However, various combinations and modifications of the features consistent with the teachings of the present disclosure may be desired for particular applications or implementations.

The disclosed system offers a comprehensive solution for improving multi-station assembly quality by integrating predictive warranty claim detection with insights into cross-station interactions. By detecting potential warranty claims for a product early, right within the assembly plant or factory, it allows manufacturers to address the quality issue before the product leaves the facility. The disclosed system also provides actionable insights into how activities/tasks across multiple stations interact, contributing to defects. The system enhances product quality, reduces warranty costs, and improves overall assembly efficiency. As manufacturing processes become more complex, this system provides a valuable tool for maintaining high standards of quality and reliability across industries, such as, automotive, aerospace, electronics, medical device, etc.

The Predictive Warranty Claim System (PWCS) (e.g., the predictive warranty claims module) collects sensor data from multiple assembly stations, monitoring key parameters such as alignment, torque, and material properties. This data is transmitted in real-time to a central neural network, which analyzes the collective sensor data from multiple assembly stations. The neural network may include a deep learning neural network such as a long short-term memory (LSTM) neural network, although integration of other neural networks are contemplated such as recurrent neural network (RNN) or a convolutional neural network (CNN) merely as examples. The system's deep learning model(s) analyze the collective data as sequential data, recognizing early defect indicators by flagging deviations from normal sensor readings.

The PWCS enables real-time monitoring, where sensors capture, e.g., continuously capture, critical data, including but not limited to torque, temperature, and alignment, at each station in the manufacturing facility (e.g., automotive, aerospace, medical device, electronics, etc. assembly plant). This information is processed by the neural network model, which evaluates variations that could indicate potential defects. Through proactive fault detection, the model recognizes complex fault patterns that traditional methods may overlook. For example, a slight misalignment at one station combined with a torque deviation at another could contribute to a defect in later assembly stages. By detecting these interactions early, the system preemptively flags potential issues before they escalate.

Additionally, the PWCS optimizes sensor tolerance limits dynamically. Using historical data, the system adjusts detection thresholds to balance false positives and fault detection accuracy, ensuring that only meaningful deviations are flagged while reducing unnecessary alerts. This adaptive thresholding improves the reliability of defect detection across the assembly process.

The Cross-Station Interaction Detection System (CSIDS) (e.g., the cross-station interaction detection module) extends beyond identifying warranty claims by analyzing how interactions between different assembly stations contribute to final product defects. Using rule extraction techniques, the system uncovers patterns that lead to defects, making neural network predictions more interpretable by translating them into human-readable rules.

Through rule extraction from the neural network model, the system transforms complex neural network predictions into actionable insights. These extracted rules identify which combinations of parameters across different stations are most likely to cause defects. For example, if a torque deviation occurs at Station A and a temperature fluctuation is detected at Station B, the system may predict that a defect will arise at Station C. This predictive capability allows manufacturers to anticipate and mitigate defects before they materialize.

The system and method also identify cross-station dependencies, focusing on how interactions across multiple stations contribute to defects. By recognizing these dependencies, manufacturers can optimize processes and address inter-station interactions that lead to quality issues. Understanding how variations in one station impact subsequent stages enables proactive adjustments to prevent cascading failures in production.

To enhance usability, the system provides real-time alerts when critical cross-station interactions are detected. These alerts enable operators to intervene before defects propagate through the assembly line. Additionally, a visual interface displays sensor data alongside extracted rules, offering transparency into the assembly process. This interface allows operators to track and respond to potential quality issues more effectively, ensuring better control over production outcomes.

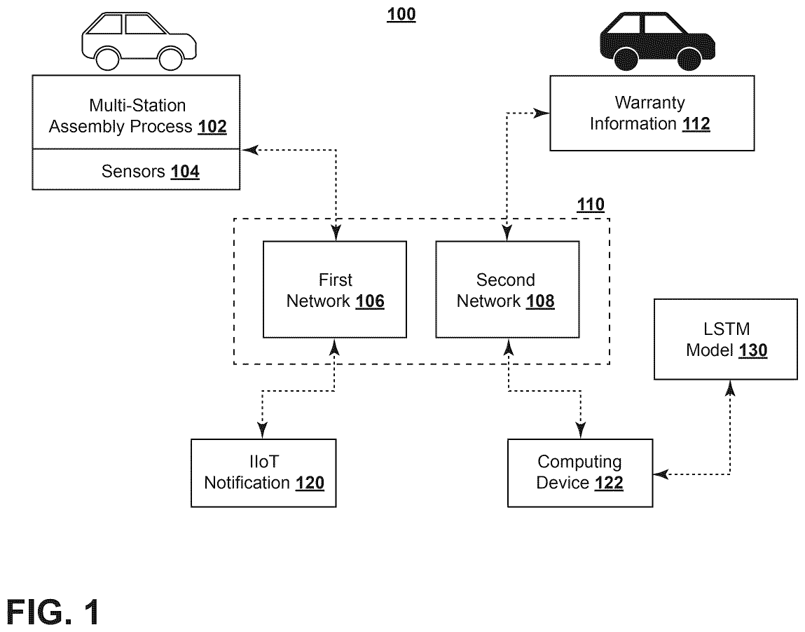

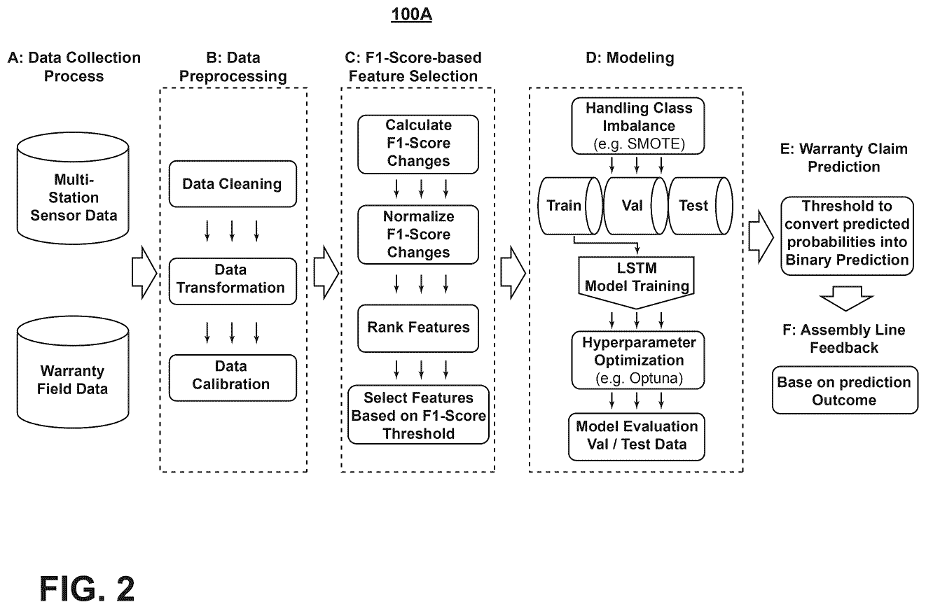

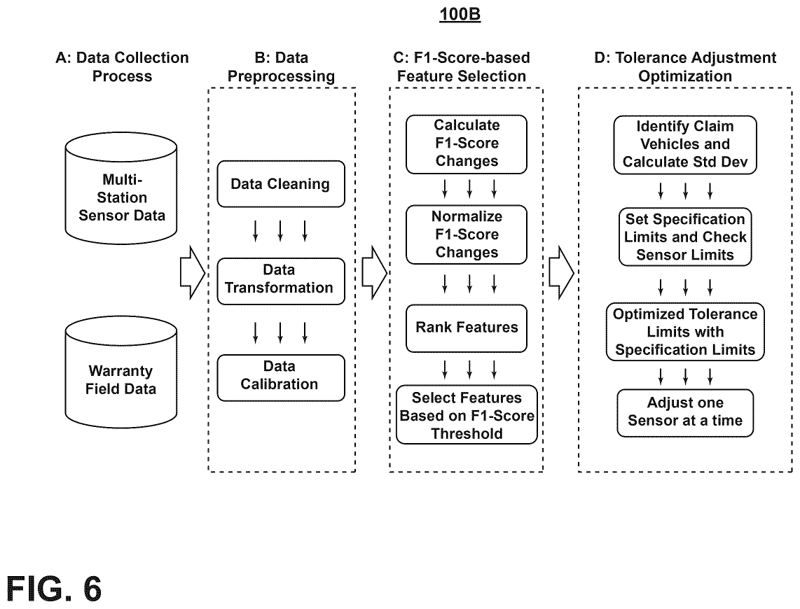

In examples, FIG. 1 generally illustrates an example system 100 for predictive warranty claims detection (e.g., as conducted via predictive warranty claims detection module 100A of FIG. 2) and/or cross-station interaction detection analysis (e.g., as conducted via cross-station interaction detection module 100B of FIG. 6) in an industrial/automotive final assembly environment. It will be appreciated, however, that the system 100 may be employed in other environments such as electronics, machines, aerospace, medical device, and original equipment manufacturer (OEM) facilities, without departing from the scope of the disclosure. As used herein, a product is intended to mean a component requiring multi-station assembly, such as a vehicle (land, water, air, space) or equipment thereof, medical device, electronics, machines (e.g., electric motors, pumps, etc.), and the like. The system 100 may be configured to collect sensor data from a multi-station assembly process 102, correlate the sensor data with product identifiers and assembly station identifiers, and/or apply machine-learning models to detect early defect patterns and critical cross-station interactions. The multi-station assembly process 102 may represent an automotive final assembly line in which vehicles sequentially pass through a plurality of assembly stations. Each assembly station may perform one or more assembly operations such as fastening, alignment, and/or component installation. Each vehicle may be associated with a vehicle identifier, and each station may be associated with an assembly station identifier, further allowing sensor readings to be tracked per vehicle and per station via the system 100.

The system 100 (e.g., integrated with the multi-station assembly process 102) may include any number and/or variety of sensors 104. The sensors 104 and/or a connected computing device 122 may monitor assembly parameters, for example alignment, torque, temperature, and/or material properties; and can generate corresponding sensor data indicative of the assembly parameters for individual vehicles. The sensors 104 may include, without limitation, torque transducers, position encoders, temperature sensors, vision systems, and/or other industrial sensors. In examples, sensor data derived from the sensors 104 is transmitted via a first network 106, which may be implemented as a plant level production network and/or Industrial Internet of Things (IIoT) network. The first network 106 may be configured to receive sensor data as each vehicle progresses through the stations and/or may transmit the data to one or more networks (e.g., data stores) and/or to computing device 122. Further, as shown in FIG. 1, a second network 108 represents a postproduction data network that may receive/include warranty related information, including warranty claim records, from field data sources such as service centers, dealer systems, vehicle telematics, and/or onboard diagnostic systems. Each warranty claim record can be associated with a vehicle identifier, one or more claim types, and/or additional metadata, allowing linkage to production time sensor data.

In examples, a logical network 110 may include the first network 106 and the second network 108. The first network 106 and the second network 108 may be implemented as separate network domains bridged by secure gateways, or as different logical segments of a unified physical infrastructure. The logical network 110 is configured to receive and store data in association with vehicle identifiers and assembly station identifiers in executing the various embodiments presented below. Further, the computing device 122 may be communicatively coupled to the logical network 110 and may be implemented as a server, server cluster, cloud service, or other computing platform. As illustrated later in FIG. 10, the computing device 122 may include one or more processors, system memory, storage, an I/O interface, and/or a network adapter. The computing device 122 may be operable execute one or more program modules, including a predictive warranty claim module 100A (e.g., the process flow shown in FIG. 2) and/or a cross-station interaction detection module 100B (e.g., the process flow shown in FIG. 6).

With embodiments, the computing device 122 can be configured to receive sensor data from the sensors 104 via the first network 106, receive warranty-related information via the second network 108, and correlate the data on a per-vehicle and per-station basis using vehicle identifiers and assembly station identifiers. The correlated data may provide training and/or inference inputs for a neural network model 130 (e.g., long short-term memory (LSTM) neural network) and other models used by the predictive warranty claims module 100A and/or the cross-station interaction detection module 100B. Additionally, in some embodiments, a notification component 120 is configured to output one or more notifications to plant personnel and/or external systems when a likelihood that a given vehicle will lead to a warranty claim satisfies a defect-risk criterion and/or when critical cross-station interactions are detected. The one or more notifications may be delivered through a user interface, an and-on system, a manufacturing execution system, or other plant control systems.

In examples, FIG. 2 generally illustrates a high-level workflow implemented by system 100 for predicting warranty claims using machine learning (e.g., as executed via the predictive warranty claims module 100A). The workflow includes data collection, preprocessing, feature selection, modeling, prediction, and/or assembly-line feedback. At a first stage (A), a data collection stage, the system 100 may collect/receive sensor data from multiple stations in the assembly line 102. Each station may have multiple sensors 104 monitoring various aspects of the assembly process, for example, torque, alignment, and/or temperature. The collected sensor data is organized into a dataset that includes measurements for each vehicle along with associated vehicle identifiers and/or assembly station identifiers.

With further embodiments, the system 100 may collect warranty claims data 112 via the second network 108. Warranty claims data may include a variety of information, such as: whether a vehicle has had a warranty claim, for example, 1 for warranty claim and 0 for no warranty claim. This warranty claim label serves as the target output for the predictive model. At a second stage (e.g., preprocessing stage B), the computing device 122 cleans, transforms, and/or calibrates the collected data to ensure consistency and/or remove noise. Data cleaning operations may remove and/or impute missing values, filter outliers, and/or align timestamps; and data calibration may transform raw sensor values into engineering units and/or harmonize scales across the plurality of sensors 104.

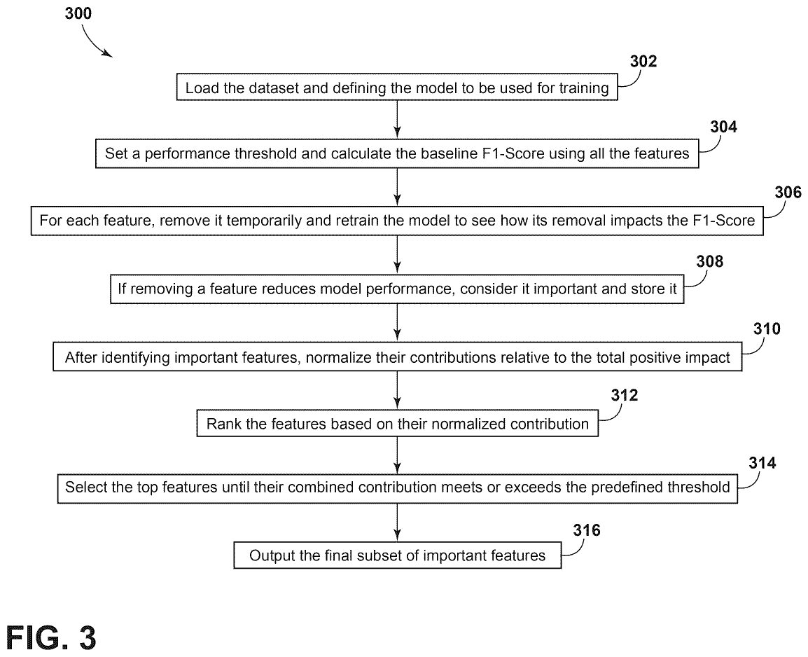

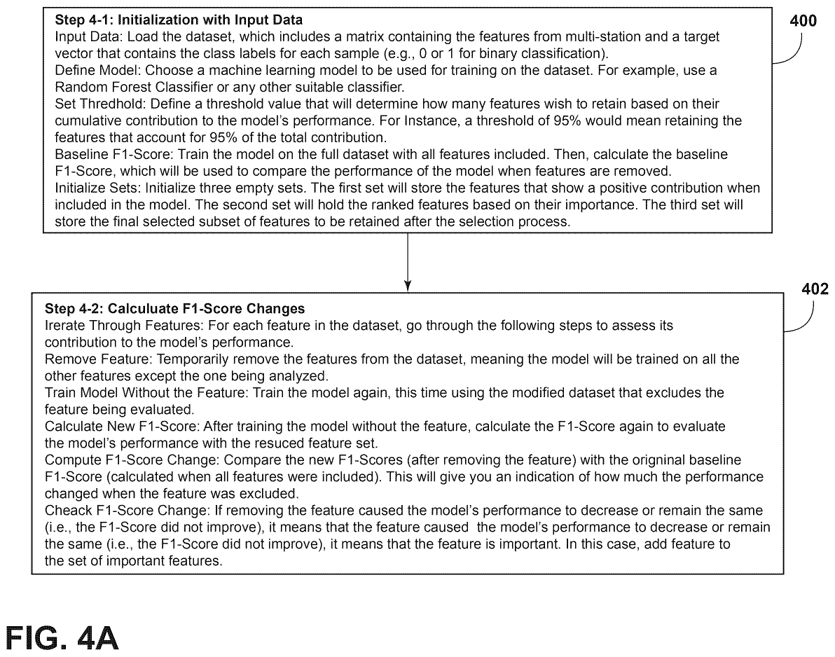

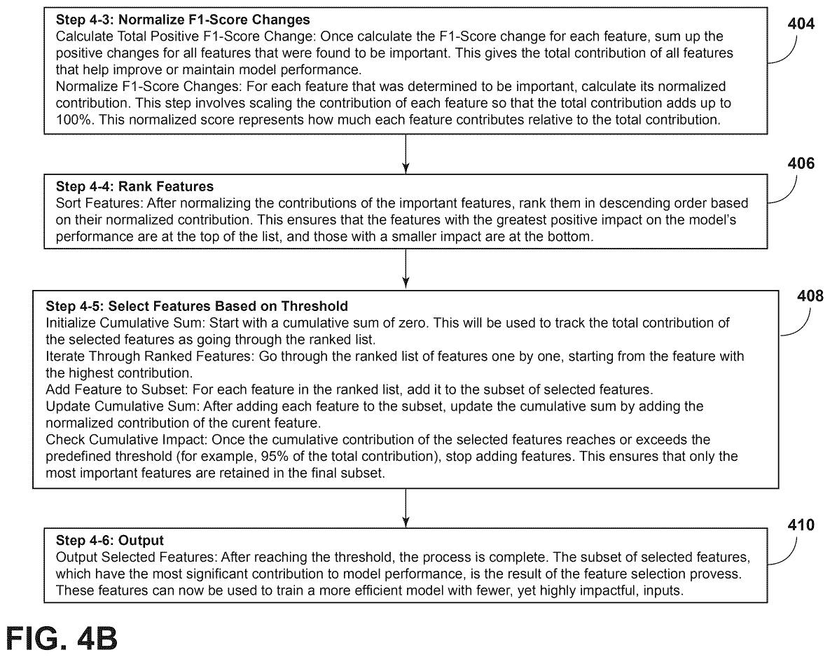

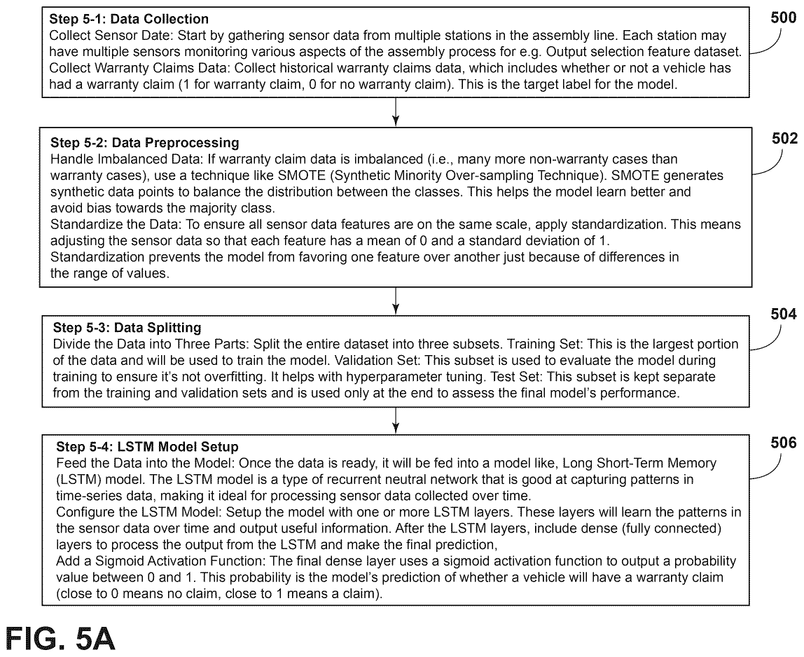

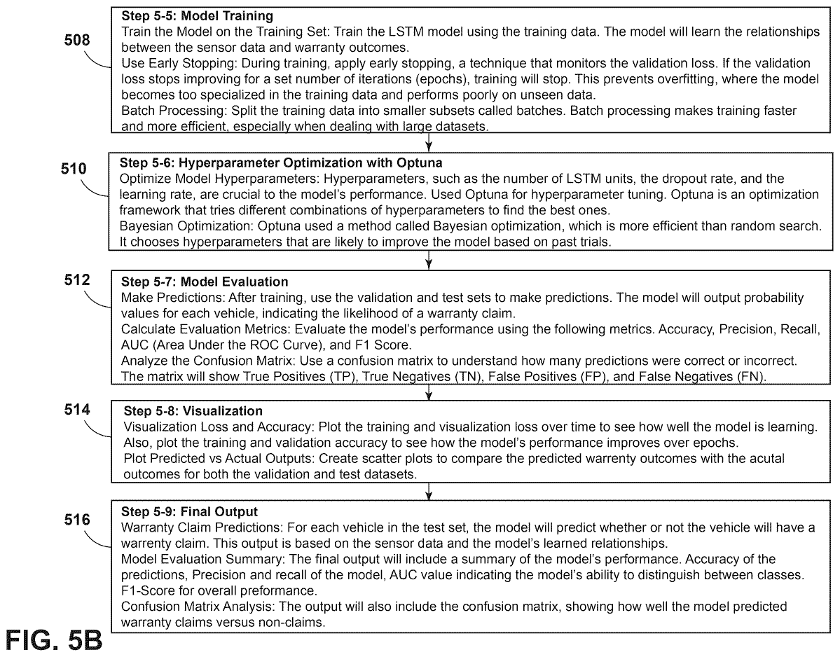

In examples, the computing device 122 may be operable for feature selection (e.g., stage C), which may be performed based on changes in an F1-score, as shown in FIGS. 3, 4A, and 4B, to identify a subset of features that most significantly contribute to prediction performance. A predictive model, such as an LSTM model 130, is then trained and evaluated (e.g., stage D) as detailed in FIGS. 5A and 5B. Once trained, the predictive model can be deployed to receive sensor data in real time as vehicles proceed through the assembly process and/or the predictive model can generate predictions indicative of the likelihood that a given vehicle will lead to a warranty claim. The one or more notifications produced by the predictive warranty claims module 100A allow plant personnel to perform inspection and/or adjustment before vehicles leave the assembly plant (e.g., stages E and F).

With embodiments, FIGS. 3, 4A, and 4B illustrate a feature selection process using F1-score changes that can be implemented by system 100 (e.g., the predictive warranty claims module 100A). The feature selection process (300) identifies important features based on how removal of each feature affects the F1-score of a classification model. As shown in FIG. 3, the feature selection process may include one or more steps, such as loading the dataset and defining the model to be used for training (302). Next, the feature selection process may involve setting a performance threshold and calculating the baseline F1-score using all features (304), and for each feature, removing it temporarily, and retraining the model to see how its removal impacts the F1-score (306). If removing a feature reduces the model performance, consider it important and store it (308). After identifying one or more important features, normalize their contributions relative to the total positive impact (310). The feature selection process may involve ranking the features based on their normalized contribution (312), and/or selecting the top features until their combined contribution meets or exceeds the predefined threshold (314). Additionally, the feature selection process may include outputting the final subset of important features (316).

In a first step (Step 4-1), the computing device 122 may be operable to initialize the system 100 with input data (400). The computing device 122 inputs the data by loading a dataset which includes a matrix containing the features from multi-station sensor data and/or a target vector that contains the class labels for each sample, for example, 0 or 1 for binary classification. The computing device 122 then defines the model by choosing a machine learning model to be used for training on the dataset. For example, the model may be a Random Forest Classifier or any other suitable classifier. The computing device 122 may be operable to set a threshold by defining a threshold value that will determine how many features are to be retained based on their cumulative contribution to the model's performance. For instance, a threshold of 95 would mean retaining the features that account for 95 percent of the total contribution. The computing device 122 may be operable to determine a baseline F1-score by training the model on the full dataset with all features included and then calculating a baseline F1-Score (e.g., which is used to compare the performance of the model when individual features are removed). The computing device 122 may be operable to initialize sets (e.g., three empty sets, although more or less may be chosen depending on the circumstances). A first set is configured to store the features that show a positive contribution when included in the model; a second set is configured to hold the ranked features based on their importance; and/or a third set is configured to store the final selected subset of features to be retained after the selection process.

In a second step (Step 4-2), the computing device 122 calculates F1-score changes 402. For example, the computing device 122 may be configured to iterate through features, in which, for each feature in the dataset, a sequence of operations is performed to assess that feature's contribution to the model's performance (402). The computing device 122 may be configured to remove one or more features by temporarily removing the feature from the dataset, meaning that the model is trained on all other features except the feature being analyzed. The computing device 122 may be configured to train the model again using the modified dataset that excludes the feature being evaluated. The computing device 122 may calculate a new F1-Score to evaluate the model's performance with the reduced feature set. Further, the computing device 122 may be operable to compare the new F1-Score after removing the feature with the original baseline F1-Score calculated when all features were included, to indicate how much the performance changed when the feature was excluded. The computing device 122 may be operable to check if removing the feature causes the model's performance to decrease or remain the same, that is, the F1-Score does not improve, the feature is considered important, and the computing device 122 adds the feature to the set of important features.

In a third step (Step 4-3), the computing device 122 normalizes F1-score changes (404). For example, the computing device 122 may be operable to calculate total positive F1-Score change. Once the F1-Score change is calculated for each feature, the computing device 122 sums the positive changes for all features identified as important (e.g., this sum represents the total contribution of all features that help improve or maintain model performance). The computing device 122 may normalize F1-Score changes, further, for each feature that is determined to be important, a normalized contribution can be calculated. This third step involves scaling the contribution of each feature so that the total contribution adds up to 100 percent or 1.0, and the normalized score represents how much each feature contributes relative to the total contribution.

In a fourth step (Step 4-4), the computing device 122 may rank or sort features (406). Further, the computing device 122 may rank/sort the important features in descending order based on their normalized contribution. Such ordering may ensure that the features with the greatest positive impact on the model's performance are at the top of the list, and those with a smaller impact are at the bottom.

In a fifth step (Step 4-5), the computing device 122 may select features based on a threshold (408). Further, the computing device 122 may be operable to initialize a cumulative sum variable to zero. The cumulative sum can be used to track the total contribution of the selected features while iterating through the ranked list. The computing device 122 may be operable to iterate through the ranked list of important features one by one, starting from the feature with the highest normalized contribution. For each feature in the ranked list, the computing device 122 may be operable to add it to the subset of selected features. The computing device 122 may be configured to update the cumulative sum after adding each feature to the subset, by adding the normalized contribution of the current feature. Further, the computing device 122 may then check the cumulative impact, in that once the cumulative contribution of the selected features reaches or exceeds the predefined threshold, for example, 95 percent of the total contribution, the computing device 122 stops adding features, ensuring that only the most important features are retained in the final subset.

In a sixth step (Step 4-6), the computing device 122 may be operable to output one or more selected features (410). Further, after reaching the predefined threshold, the feature selection process is complete, and the subset of selected features, which have the most significant contribution to model performance, is output as the result of the feature selection process. These features can be used to train a more efficient model with fewer, yet highly impactful, inputs.

In examples, FIGS. 5A and 5B illustrate an example warranty prediction model process that may be implemented by the predictive warranty claims module 100A executing on the computing device 122. In a first step (Step 5-1), the computing device 122 collects data. For example, the computing device 122 may be configured to collect sensor data from multiple stations in the assembly line (500). Each station may have multiple sensors monitoring various aspects of the assembly process, for example, torque, temperature, and/or alignment, and the sensor data may be organized into features for each vehicle. The computing device 122 may be operable to collect warranty claims data 112, (e.g., via the second network 108) which includes whether a vehicle has had a warranty claim, with 1 indicating a warranty claim and 0 indicating no warranty claim. This binary label may be used as the target label for the model.

In a second step (Step 5-2), the computing device 122 may be operable for data preprocessing (502). For example, the computing device 122 may manage imbalanced data processing, via using a technique like Synthetic Minority Over-sampling Technique (SMOTE). Further, if the warranty claim data is imbalanced, for example, where there are many more non-warranty cases than warranty cases, the computing device 122 uses SMOTE to generates synthetic data points to balance the distribution between the classes, helping the model learn better and avoid bias toward the majority class. The computing device 122 is operable to apply standardization to the data to ensure all sensor data features are on the same scale. Further, standardization adjusts the sensor data so that each feature has a mean of 0 and a standard deviation of 1, preventing the model from favoring one feature over another solely due to differences in value ranges.

In a third step (Step 5-3), the computing device 122 may be operable for data splitting (504). In examples, the computing device may be operable to spit the entire dataset into three subsets. The training set (e.g., the first subset) is the largest portion of the data and is used to train the model; the validation set (e.g., the second subset) is used to evaluate the model during training to ensure it is not overfitting and to support hyperparameter tuning; and the test set (e.g., the third subset) is kept separate from the training and validation sets and, in embodiments, may be used only at the end to assess the final model's performance.

In a fourth step (Step 5-4) the computing device 122 may be operable for configuring the deep learning neural network model (e.g., LSTM model) 130 (506). Further, the computing device 122 may transmit the data into the LSTM model 130. According to an implementation, the neural network model 130 may be a type of recurrent neural network (e.g., LSTM neural network) well-suited for capturing patterns in time-series data (e.g., such as used with an assembly line). The computing device 122 may configure the LSTM model 130 by setting up the model with one or more LSTM layers. The one or more LSTM layers may learn patterns in the sequential sensor data and/or may produce intermediate representations. After the one or more LSTM layers, the computing device 122 may include one or more dense layers (e.g., fully connected) to process the LSTM outputs and/or generate a final prediction. The computing device 122 performs Add a Sigmoid Activation Function processing, in which the final dense layer uses a sigmoid activation function to output a probability value between 0 and 1, representing the model's prediction of whether a vehicle will have a warranty claim, with values close to 0 indicating no claim and values close to 1 indicating a claim.

In a fifth step (Step 5-5), the computing device 122 may be operable for model training (508). Further, the computing device 122 may train the LSTM model 130 using the training data so that the model learns the relationships between the sensor data and the warranty outcomes. The computing device 122 may use early stopping as a technique that monitors the validation loss. If the validation loss stops improving for a set number of iterations (e.g., epochs), training is stopped to prevent overfitting to avoid the model becoming too specialized to the training data thus performing poorly on unseen data. The computing device 122 may be operable for batch processing by splitting the training data into smaller subsets (e.g., batches), which makes training faster and more efficient, particularly for large datasets.

In a sixth step (Step 5-6), the computing device 122 may be operable for hyperparameter optimization (510). In examples, the computing device 122 may be configured to optimize model hyperparameters, such as the number of LSTM units, the dropout rate, and/or the learning rate, which are connected to the model's performance. The computing device 122 may employ an optimization framework, such as Optuna, for hyperparameter tuning. Optuna may try different combinations of hyperparameters to find a configuration that yields improved performance on a validation set. In some embodiments, Optuna may use a method called Bayesian optimization, which is more efficient than random search because it chooses hyperparameters that are likely to improve the model based on results of past trials.

In a seventh step (Step 5-7), the computing device 122 may be operable for model evaluation (512). After training and hyperparameter optimization, the computing device 122 may use the validation and/or test sets to make predictions. The LSTM model 130 may output probability values for each vehicle, indicating the likelihood of a warranty claim. The computing device 122 may calculate one or more evaluation metrics, for example, Accuracy, Precision, Recall, Area Under the ROC Curve (AUC), and/or F1-Score, to assess the model's performance. Additionally, in examples, the computing device 122 may be operable to generate and analyze a confusion matrix to understand how many predictions were correct or incorrect, where the confusion matrix reports True Positives (TP), True Negatives (TN), False Positives (FP), and/or False Negatives (FN).

In an eighth step (Step 5-8), the computing device 122 may be operable for visualization of model behavior (514). The computing device 122 may plot the training and validation loss over time to see how well the model is learning and/or whether overfitting is occurring. The computing device 122 may also plot the training and/or validation accuracy over epochs to observe how the model's performance improves and/or plateaus. Further, the computing device 122 may generate scatter plots (e.g., or other suitable visual representations) comparing predicted warranty outcomes with actual outcomes for both the validation and test datasets, thereby allowing engineers to visually inspect agreement or deviation between predictions and ground truth.

In a ninth step (Step 5-9), the computing device 122 may be operable to provide a final output for warranty claim prediction (516). For each vehicle in the test set, and for vehicles processed online in the assembly plant, the LSTM model 130 may predict whether or not the vehicle will have a warranty claim based on the sensor data and the model's learned relationships. The computing device 122 may be operable to generate a model evaluation summary that can include, for example, the accuracy of the predictions, the precision and recall of the model, the AUC value indicating the model's ability to distinguish between classes, and the F1-Score representing overall performance. The computing device 122 may be operable to present and/or store the confusion matrix as part of a confusion matrix analysis, showing how well the model predicted warranty claims versus non-claims, and/or may use these outputs to drive notifications or other control actions within the assembly process.

With examples, FIG. 6 shows a block-system diagram for a cross-station interaction detection module 100B (e.g., system) that may operate independently from and/or in conjunction with the predictive warranty claims module 100A (e.g., within an automotive final assembly environment). In embodiments, a data collection process may acquire multi-station-sensor data from an assembly line as well as post-production warranty field data from service centers, dealer systems, and/or vehicle telematics. The multi--station sensor data may include measurements of torque, temperature, alignment, and/or other process parameters collected as each vehicle passes through multiple assembly stations; the warranty field data may include records indicating whether a vehicle experienced a warranty claim and/or, in some cases, a type and/or severity of the claim.

Further, the sensor data from the various stations may be transmitted over the first network 106 and/or may be stored in a production data network and/or data repository associated with the plant or facility. The warranty field data may be transmitted over the second network 108 and stored in a postproduction data repository. The cross-station interaction detection module 100B may operate on a combined view of these data sources, in which the production time multi-station sensor data and the postproduction warranty field data are linked/joined based on vehicle identifiers and, optionally, time stamps or other correlation fields. By linking these data sources, the cross-station interaction detection module 100B may evaluate how process conditions at specific stations contribute to warranty outcomes observed in the field.

In some embodiments, as illustrated in FIG. 6, the cross-station interaction detection module 100B may include a data preprocessing stage configured to perform data cleaning, data transformation, and/or data calibration on the multi-station sensor data and/or the warranty field data. With embodiments, data cleaning may include removing or imputing missing values, filtering out inconsistent or out of range readings, and/or resolving duplicated records. Data transformation may include aggregating or reshaping the sensor data into station wise or timeseries feature vectors, generating derived features such as gradients or moving statistics, and/or converting categorical information into numerical encodings. In examples, data calibration may include converting raw sensor signals into engineering units, normalizing or standardizing the features, and/or aligning sampling intervals or time stamps across different stations so that the resulting dataset is consistent and suitable for subsequent modeling.

The cross-station interaction detection module 100B may further include an F1-score-based feature selection stage that is configured to operate on the preprocessed data. In this stage, the computing device 122 may calculate changes in F1-Score when individual features are removed from a baseline classification or prediction model, normalize the F1-Score changes to obtain relative contributions of each feature, rank the features based on their normalized contributions, and/or select a subset of features whose cumulative contribution exceeds a threshold. In the cross-station interaction detection module 100B context, these features may represent sensor variables at specific stations, interaction indicators involving multiple stations, and/or derived statistical features that are most informative for predicting warranty outcomes.

In a tolerance adjustment optimization stage, the cross-station interaction detection module 100B may identify machines or equipment (e.g., vehicles, medical devices, electronics, etc.) associated with warranty claims spanning all claim types and/or calculate statistical measures, such as standard deviations of sensor values, for the machines or equipment. The cross-station interaction detection module 100B may then evaluate existing specification limits for the sensors in the context of the complete warranty claim landscape and determine whether the current limits adequately separate claim and non-claim populations across all identified claim categories. Optimized tolerance limits may be determined through a unified, joint optimization framework in which tolerance limits for all relevant sensors are evaluated concurrently (e.g., all system sensors are evaluated jointly or simultaneously). In particular, where a product may be associated with multiple distinct warranty claim types, the optimization may incorporate all such claim types simultaneously and determine a coordinated set of tolerance limits that minimizes aggregate false-positive and false-negative rates across the full claim population. The optimization may further account for overall detection performance, cost of false alarms, and cost of missed detections in a comprehensive and integrated manner. By jointly optimizing tolerance limits across all sensors and warranty claim types for an associated product (e.g., machine or equipment), the system may generate a globally consistent set of specification and tolerance thresholds that more effectively distinguish defect-prone conditions while maintaining alignment with overall quality objectives and cost considerations.

The cross station interaction detection module 100B executing on the computing device 122 may use rule extraction techniques applied to a trained neural network model 130 (e.g., an LSTM model or other predictive model) to transform complex model behavior into human readable rules. These rules may describe relationships between combinations of sensor parameters across different stations and the probability of a defect or warranty claim. For example, a rule may specify that if torque at a first station exceeds a threshold and temperature at a second station is below a threshold, then the likelihood of a defect at a third station increases above a specified level. By aggregating and presenting such rules, the cross-station interaction detection module 100B may identify cross-station dependencies and/or interaction patterns that are not apparent when stations are analyzed in isolation.

In operation, the cross-station interaction detection module 100B may output both optimized tolerance recommendations and rule-based cross-station interaction insights to one or more user interfaces or plant-level systems. Plant engineers and/or operators may use these outputs to adjust station settings, modify task tolerances, and/or focus inspection and rework resources on vehicles and stations that exhibit critical interaction patterns. Accordingly, the cross-station interaction detection module 100B not only analyzes dependencies between stations and identifies interactions that contribute to defects but also provides actionable guidance for process optimization and quality improvement across the multi-station assembly line.

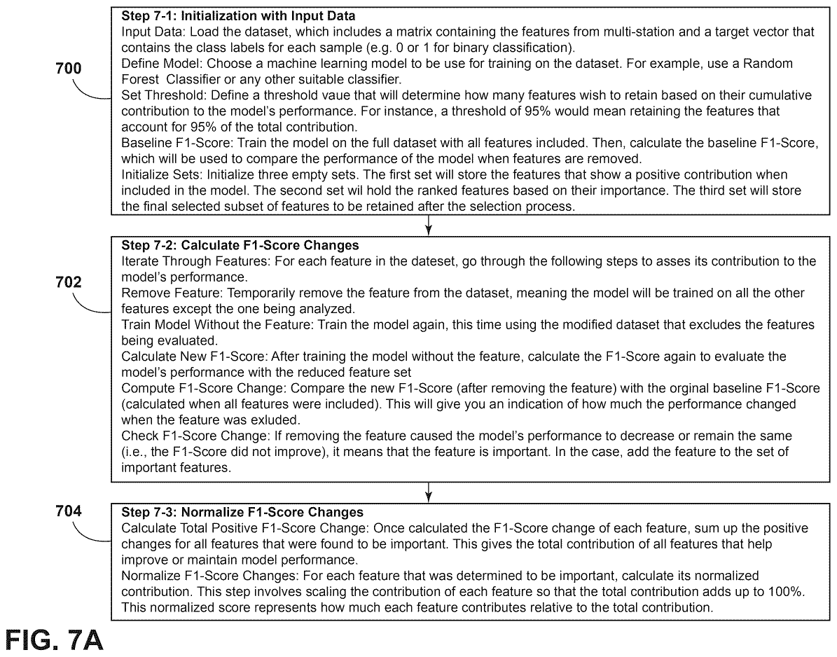

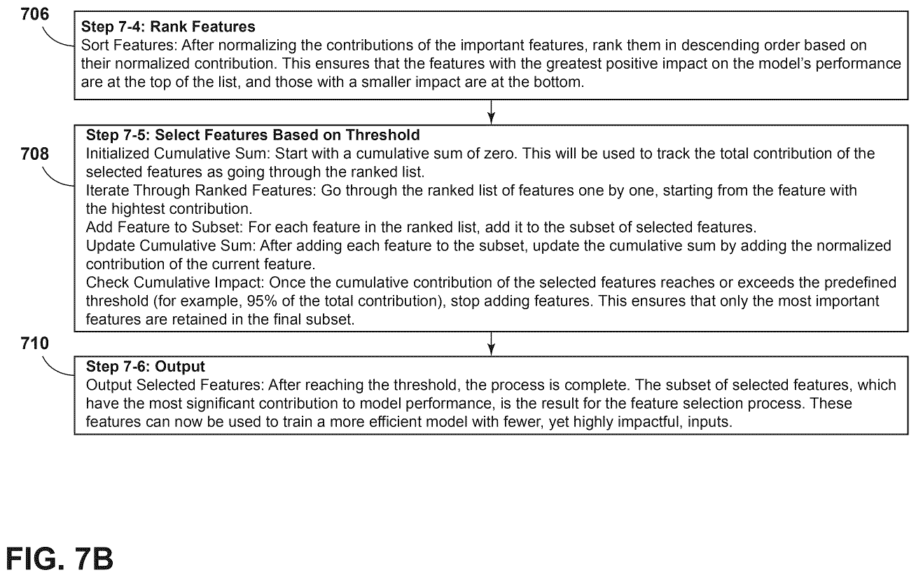

FIGS. 7A and 7B depict a feature selection process for the cross-station interaction detection module 100B using F1-Score changes. The process may be similar to the steps described with respect to FIGS. 3, 4A, and 4B thus, may involve a similar sequence of Step 4-1 through Step 4-6. In the cross-station interaction detection module 100B context, the features represent multi-station sensor variables and derived interaction indicators, and the selected feature subset emphasizes those variables most informative for detecting cross-station interactions leading to defects.

In some embodiments, the cross-station interaction detection system includes a cost-optimized tolerance limit adjustment framework, as illustrated by a tolerance-optimization diagram. The framework may use an evolutionary optimization algorithm, such as NSGA-II, to search for sensor tolerance limits that minimize a cost associated with detection errors during warranty claim prediction.

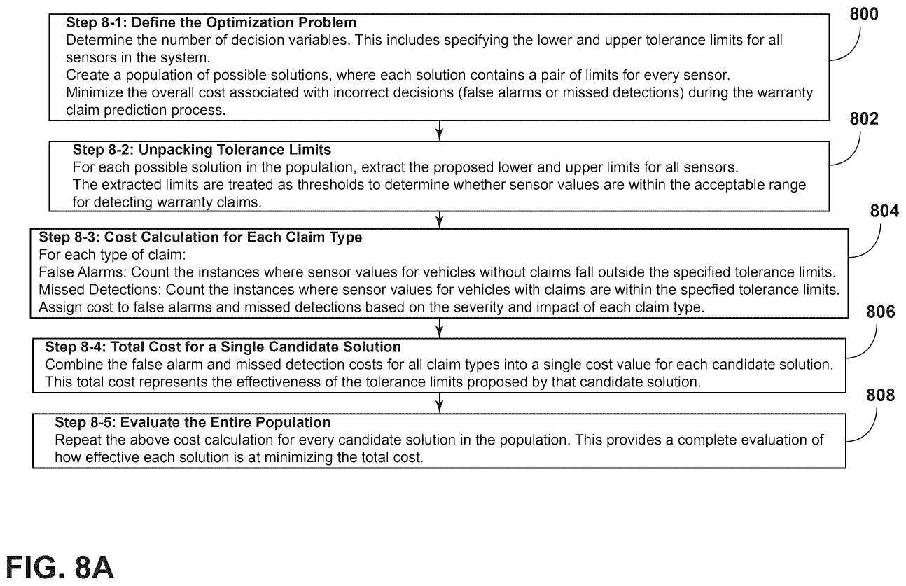

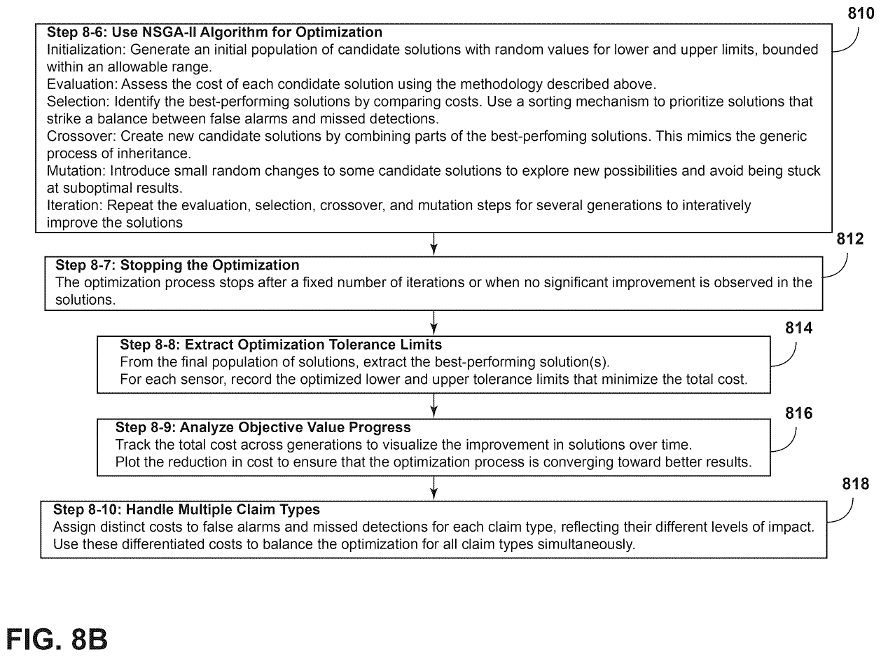

In examples, FIGS. 8A and 8B show a flow process for cost-optimized tolerance limit adjustment for multi-station sensor warranty claim detection.

In a first step (Step 8-1), the computing device 122 may be operable to define an optimization problem for tolerance limit adjustment (800). In examples, the computing device 122 may determine a number of decision variables including, for each sensor in the system (e.g., all system sensors jointly), a lower tolerance limit and/or an upper tolerance limit to be optimized. The computing device 122 may then generate a population of candidate solutions, where each candidate solution includes a pair of limits (e.g., a lower limit and an upper limit) for every sensor. The computing device 122 may further define an objective function configured to minimize an overall cost associated with incorrect decisions during the warranty claim prediction process, such as costs attributable to false alarms and missed detections.

In a second step (Step 8-2), the computing device 122 may be operable for unpacking tolerance limits (802). For each candidate solution in the population, the computing device 122 may extract the proposed lower and upper tolerance limits for all sensors. The extracted limits may be applied as thresholds that determine whether individual sensor values are considered within an acceptable range for detecting potential warranty claims.

In a third step (Step 8-3), the computing device 122 may be operable to determine cost calculation for each warranty claim type (e.g., all warranty claim types for an associated product) (804). For each type of warranty claim, the computing device 122 may count false alarms by determining instances in which sensor values for vehicles without claims fall outside the specified tolerance limits, and/or may count missed detections by determining instances in which sensor values for vehicles with claims remain within the specified tolerance limits. The computing device 122 may then assign one or more cost values to the counted false alarms and/or missed detections based on the severity and impact associated with each claim type.

In a fourth step (Step 8-4), the computing device 122 may be operable to determine a total cost for each candidate solution (806). For each candidate solution, the computing device 122 may combine the false-alarm costs and missed-detection costs across all claim types into a single cost value. This aggregate cost value may represent an effectiveness measure for the set of tolerance limits proposed by the corresponding candidate solution.

In a fifth step (Step 8-5), the computing device 122 may be operable to evaluate the entire population of candidate solutions (808). The computing device 122 may repeat the cost-calculation procedure for every candidate solution in the population, thereby generating a cost value for each solution and/or providing a complete evaluation of how effective each solution is at minimizing the total cost.

In a sixth step (Step 8-6), as generally illustrated in FIG. 8B, the computing device 122 may be operable to perform optimization using an NSGAII algorithm or another evolutionary optimization technique (810). The computing device 122 may initialize the algorithm by generating an initial population of candidate solutions with random lower and upper tolerance limits that are bounded within an allowable range. The computing device 122 may then evaluate each candidate solution by computing its cost value as described above. Based on these cost values, the computing device 122 may perform selection by identifying better performing solutions and using a sorting or ranking mechanism to prioritize solutions that achieve a desirable balance between false alarms and missed detections. The computing device 122 may perform crossover by creating new candidate solutions through combining limit values from pairs of selected solutions, and/or may perform mutation by introducing small random changes to some tolerance limits to explore new regions of the solution space and reduce the likelihood of convergence to suboptimal solutions. The computing device 122 may repeat evaluation, selection, crossover, and/or mutation operations over multiple generations to iteratively improve the population of candidate solutions.

In a seventh step (Step 8-7), the computing device 122 may be operable to stop/halt/pause the optimization process (812). In some embodiments, the optimization may terminate after a fixed number of generations or iterations. In other embodiments, the optimization may stop when the computing device 122 determines that no significant improvement in the cost values of candidate solutions is observed over one or more successive generations.

In an eighth step (Step 8-8), the computing device 122 may be operable to extract optimized tolerance limits (814). From the final population of candidate solutions, the computing device 122 may identify one or more best performing solutions according to the cost values. For each sensor, the computing device 122 may record optimized lower and/or upper tolerance limits taken from the selected best performing solution or solutions, wherein the optimized limits correspond to reduced overall cost.

In a ninth step (Step 8-9), the computing device 122 may be operable to analyze objective value progress (816). The computing device 122 may track the total cost values of candidate solutions across generations to monitor improvement during optimization. In some embodiments, the computing device 122 may generate one or more plots (e.g., or other visualizations of cost reduction over generations) to confirm that the optimization process converges toward improved solutions.

In a tenth step (Step 8-10), the computing device 122 may be operable to handle multiple claim types within the optimization framework (818). The computing device 122 may assign distinct cost weights to false alarms and/or missed detections for each claim type so as to reflect different severities or business impacts. The computing device 122 may then use these differentiated costs when computing total cost values, thereby balancing the optimization across all claim types simultaneously and/or producing tolerance limits that account for heterogeneous warranty-claim profiles.

In some embodiments, the disclosed models and feature selection frameworks described herein may further employ transfer learning to accelerate deployment on new product platforms (e.g., vehicles, machines, electronics, medical devices, or other product requiring assembly) and reduce early launch quality problems. For example, the neural network model (e.g., LSTM model 130) and associated cross-station interaction rules may first be trained using multi-station sensor data and warranty outcomes collected from a baseline (pre-existing) product such as a four door vehicle program merely as an example. When a new product program is introduced (e.g., a new vehicle), the computing device 122 may initialize one or more predictive warranty claims modules and cross-station interaction detection modules using parameters, feature subsets, and tolerance limit insights learned from the baseline program (e.g., historical data stored in a database), and then fine-tune those models using a comparatively smaller amount of production and warranty data from the new program. By transferring historical data such as learned temporal patterns, feature importances, and cross-station interaction structures from a pre-existing product to a new product without historical data or insufficient historical data for accurate prediction, the system 100 can more rapidly identify defect prone conditions on the new products, thereby reducing the number and severity of warranty issues and quality escapes that typically occur during early production of a new platform.

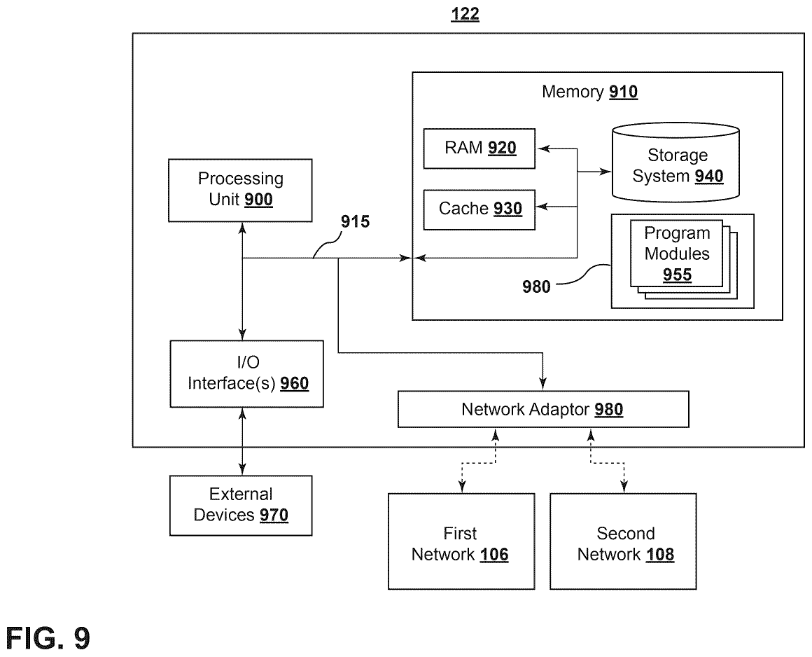

With embodiments, FIG. 9 is a high-level block diagram of an example system 100 configured for predictive warranty claims detection and cross-station interaction analysis in an multi-station product final assembly environment (such as an automotive environment), illustrating hardware and network components that may be utilized to implement the features and processes described herein. The system 100 includes one or more sensors 104 deployed along a multi-station assembly process 102, a first network 106, a second network 108, (e.g., a combined network 110) that together provide production and post-production connectivity, a computing device 122, and/or a notification component 120. The first network 106 may comprise an Industrial Internet of Things production network configured to acquire sensor data from the sensors 104 and/or associate that sensor data with vehicle identifiers and assembly station identifiers. The second network 108 may comprise a post-production network configured to receive warranty information, including warranty claim records, from field sources such as service centers and vehicle telematics, and/or to associate the warranty information with corresponding vehicle identifiers. The combined network 110 represents logical connectivity between the production and/or post-production networks, enabling the computing device 122 to correlate production-time sensor data with warranty-time outcomes.

The computing device 122 may include one or more processors 900, system memory 910, one or more storage systems 940, and/or a bus 915 that couples components within the computing device 122. The system memory 910 can include volatile memory such as random access memory 920 and cache memory 930, and the storage system 940 can include non-volatile media such as a hard drive or solid-state drive. Program code, including a predictive warranty claims module 100A, a cross-station interaction detection module 100B, and a long short-term memory (LSTM) neural network, may be stored in memory 910 as program/utility 950 with one or more program modules 955 and executed by the processors 900 to carry out the functions described herein. The computing device 122 may further include input/output interfaces 960 for communicating with external devices 970 such as operator terminals, displays, keyboards, or plant control systems, and a network adaptor 980 configured to communicate with the first network 106, the second network 108, and the combined network 110.

In operation, the sensors 104 generate sensor data that is transmitted over the first network 106 to the computing device 122 and stored in association with vehicle identifiers and assembly station identifiers, while warranty information is received over the second network 108. The computing device 122 processes this information using the LSTM-based predictive warranty claims module 100A to detect early defect patterns and determine warranty-risk levels for vehicles in process, and/or uses the cross-station interaction detection module 100B to extract human-readable rules that describe cross-station interactions contributing to defects. The notification component 120, which may be implemented as part of the computing device 122 or as a separate device coupled via I/O interfaces 960 and network adaptor 980, outputs notifications and alerts to plant personnel or external systems based on outputs from the predictive warranty claims module 100A and/or the cross-station interaction detection module 100B, enabling real-time intervention in the multi-station assembly process 102.

Implementations described herein provide specific improvements to the technical field of sensor-based defect detection in multi-station industrial assembly processes. The disclosed systems are not directed to generic data processing in the abstract, but instead are rooted in the operation of physical assembly lines, physical sensors, and industrial control networks. The disclosed long short-term memory neural network, predictive warranty claims module 100A, and cross-station interaction detection module 100B are configured to process time-series sensor data generated by the sensors 104 in real time and to cause changes in the handling of physical products and in the operation of assembly stations based on detected defect patterns.

In particular, the systems disclosed herein improve the functioning of sensor-based detection systems in the assembly environment by reducing missed detections and false alarms, optimizing sensor tolerance limits, and enabling earlier identification of vehicles likely to lead to warranty claims. The predictive warranty claims module 100A and cross-station interaction detection module 100B use the outputs of the long short-term memory neural network and the F1-score-based feature selection processes to modify sensor thresholds, adjust process parameters, and route vehicles for additional inspection or rework. These operations change how the underlying hardware and assembly process behave, rather than merely displaying information or performing mental steps.

The described feature selection procedures, hyperparameter optimization procedures, and cost-optimized tolerance-limit adjustment procedures are implemented in the context of a specific industrial system including the system 100, sensors 104, networks 106, 108, 110, and the computing device 122. These procedures are not claimed as isolated mathematical algorithms, but as integrated components of a system that improves the technological process of automotive final assembly by reducing defect rates, improving quality control, and decreasing warranty-related costs.

Accordingly, the present disclosure introduces a dual-purpose system that combines predictive warranty claims detection and the identification of critical cross-station interactions that lead to quality issues. By leveraging Industrial Internet of Things (IIoT) data and machine learning models, such as, for example, deep learning models (e.g., long short-term memory (LSTM) neural networks), the system predicts potential defects that could lead to warranty claims and identifies significant interdependencies between assembly stations. These interdependencies are crucial in detecting quality issues that affect final assembly quality, reducing the costs associated with warranty claims, and preventing recalls.

The disclosed systems and methods integrate a predictive warranty claim system (PWCS) and a cross-station interaction detection system (CSIDS). The predictive warranty claims system employs a neural network (e.g., LSTM neural network) to analyze real-time sensor data from all assembly stations. By identifying fault patterns that traditional quality control methods often miss, the system proactively predicts potential warranty claims. This early detection allows manufacturers to address defects before vehicle completion, significantly reducing warranty claims and recalls. The CSIDS utilizes rule extraction techniques from the trained neural network model to uncover critical interdependencies between assembly stations. By identifying how different stages of the assembly process influence one another, the system provides actionable insights to improve quality and prevent defects in final assembly. These combined innovations enable a more intelligent, proactive approach to manufacturing quality control.

The disclosed systems and methods may integrate a transfer learning component or module to accelerate deployment of a new product using historical data associated with a pre-existing product (e.g., a baseline product and/or a similar product). The baseline product may, for example, be a prior production model, an earlier version of the new product model, or may have other similar features or specifications. The new model may have limited or no product/warrant data, or a smaller amount of data compared to the baseline model, that can be input into a trained model effectively to provide accurate predictions or other outputs. The trained deep learning neural network and associated cross-station interaction detection modules may employ the transfer learning to accelerate deployment on new vehicle platforms and reduce early launch quality issues. The neural network and cross-station interaction rules may be initially trained using historical data (e.g., multi-station sensor data and warranty outcomes) from a baseline product or program. Upon introduction of a new product or program, the computing device may initialize predictive warranty claims modules and cross-station interaction detection modules using learned parameters, feature subsets, and tolerance limit insights from the baseline product or program, and subsequently fine-tune the modules using a comparatively smaller dataset from the new product or program. By transferring learned temporal patterns, feature importances, and cross-station interaction structures, the system may more rapidly identify defect-prone conditions associated with the new product or program, thereby reducing warranty issues and quality escapes during early production. The transfer learning facilitates efficient or rapid launch of new products by leveraging knowledge transfer (via historical data) from prior production models.

According to an aspect, a method for enhancing industrial final assembly quality by integrating predictive warranty claims detection with cross-station interaction analysis is disclosed. The method includes: receiving, via a plurality of sensors disposed at a plurality of assembly stations sensor data indicative of assembly parameters for individual products; storing, via a network, the sensor data in association with product identifiers and assembly station identifiers; analyzing, by a computing device via a predictive warranty claims module, sequential sensor data using a deep learning neural network to detect early defect indicators; determining, before completion of a given product, a likelihood that the given product will lead to a warranty claim; applying, by the computing device via a cross-station interaction detection module, rule-extraction techniques to the deep learning neural network to generate human-readable rules identifying combinations of sensor deviations of the plurality of assembly stations that contribute to defects; and providing, via at least one user interface, real-time alerts and visual indications of both predicted warranty-risk levels for individual products and critical cross-station interactions, to support modification of at least one of assembly operations and sensor tolerance limits.

The method may further include: training, via the computing device, a baseline classification model using a training dataset comprising the one or more features of the plurality of sensors and labels indicative of warranty-related outcomes; computing, via the computing device, a baseline score for the baseline classification model; and iteratively removing, via the computing device, one or more features of the plurality of sensors from the training dataset, retraining the baseline classification model, computing a corresponding score for each removal, and identifying as important features of the one or more features whose removal causes the score to at least one of decrease and fail to improve relative to the baseline score.

Pursuant to an implementation, the method may further include: normalizing, via the computing device, positive score contributions of the important features determined from the score changes so that their contributions sum to a predetermined total, rank the important features according to their normalized contributions; and selecting, via the computing device, a subset of the important features by cumulatively adding ranked features until a contribution threshold is met.

Pursuant to an implementation, the method may further include: training, via the computing device, at least one of the predictive warranty claims module and the cross-station interaction detection module using the subset of the important features resulting in a model having an improved score relative to a model trained using all the one or more features.

The method may include, additionally or alternatively, transferring historical data of the given product to a new product. The new product may have little or no associated historical data, or at least a smaller amount of sensor and warranty data than the given product. The method may include applying the historical data of the given product to the deep learning neural network to predict potential sensor deviations of the assembly stations applicable to the new product. Stated alternatively, the method may include performing transfer learning by initializing at least one predictive warranty claims module using parameters of a deep learning neural network trained on historical multi-station sensor data and warranty outcomes of a baseline product.

It will be appreciated that the disclosed systems and methods may be incorporated into various industrial assembly processes, including automotive, aerospace, medical device, machinery, and electronic industries.

Any reference in the foregoing description to data being “analyzed,” “evaluated,” “predicted,” or “optimized” by the computing device 122 is to be understood as part of an overall control scheme that affects operation of the multi-station assembly process 102, including at least one of modifying sensor tolerance limits, changing assembly-station operating parameters, and altering routing of vehicles within the assembly plant. Accordingly, the claimed subject matter as a whole is directed to patent-eligible applications of computer-implemented techniques to specific industrial machinery and processes, and not to disembodied abstract ideas.

It will be appreciated that the aforementioned, apparatus, system, and/or method may be modified to have some components and steps removed, or may have additional components and steps added, all of which are deemed to be within the spirit of the present disclosure. Accordingly, even though the present disclosure has been described in detail with reference to specific examples, it will be appreciated that the various modifications and changes can be made to these examples without departing from the scope of the present disclosure as set forth in the claims. It is anticipated and intended that future developments will occur in the technologies discussed herein, and that the disclosed method, device and/or article will be incorporated into such future developments. Thus, the specification and the drawings are to be regarded as an illustrative thought instead of merely restrictive thought.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

As used herein, terms such as “first,” “second,” “third,” and the like, relate to the illustrations shown in the figures and are not to be considered as limiting. Further, all numbers expressing dimensions, ratios and the like, used in the specification and claims, are to be understood to encompass tolerances and other deviations as represented by the term “about” or “approximately.” Moreover, all ranges disclosed herein are to be understood to encompass any and all sub-ranges subsumed therein.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. Additionally, use of adjectives such as first, second, etc. should be read to be interchangeable unless a claim recites an explicit limitation to the contrary.

It should be understood that a computer, a system, and/or a processor (e.g., ECU 44) as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The present disclosure may be implemented as a system, a device, a method, and/or a computer program product. The computer program product may include a computer-readable storage medium (or media) having computer-readable program instructions thereon for causing a processor to carry out aspects of the present disclosure.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Any memory device may incorporate electronic, magnetic, optical, and/or other types of storage media. In this context, a “non-transitory computer-readable medium” may include electronic, magnetic, optical, electromagnetic, infrared, or semiconductor-based systems, apparatuses, or devices.

Pursuant to implementations, the sensor(s) described herein may include RADAR sensors, LIDAR sensors, ultrasonic or other acoustic or proximity sensors, global navigation satellite system (e.g., GNSS) sensors, cameras, inertial measurement unit (IMU) sensors (e.g., accelerometers, gyroscopes, magnetic compasses, magnetometers), torque transducers, position encoders, temperature sensors, vision systems, and/or other sensor types employed within the industrial environment.

The flowchart and block diagrams in the figures illustrate the architecture, functionality, and operation of possible implementations of systems, methods, and computer program products. Each block may represent a module, segment, or portion of executable instructions for implementing a specific logical function. The execution order of these blocks may vary, and they may be implemented using software, hardware, or a combination of both.

Aspects of the present disclosure are described herein with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

For purposes of this document, each process associated with the disclosed technology may be performed continuously and by one or more computing devices. Each step in a process may be performed by the same or different computing devices as those used in other steps, and each step need not necessarily be performed by a single computing device.

The terms “module” and “component” as used herein generally represent software, firmware, hardware, or combinations thereof. In a software implementation, the module or component represents program code that performs specified tasks when executed on a processor. The program code may be stored in one or more computer-readable memory devices.

A software component may be coded in any of a variety of programming languages, including lower-level languages such as assembly or high-level languages such as C or C++. Assembly instructions may require conversion into machine code before execution by hardware.

Computer-executable program instructions may be loaded onto a special-purpose computer, processor, or other programmable data processing apparatus to produce a particular machine. Execution of the instructions causes one or more functions specified in the flow diagrams to be performed. These instructions may also be stored in a computer-readable storage medium that, when executed, directs a device to function in a specific manner.

Although some methods are described sequentially, the ordering is flexible unless explicitly stated otherwise. Certain operations may be rearranged or performed concurrently. Additionally, for simplicity, the figures may not show all possible interactions between different components.

Any of the disclosed methods can be implemented as computer-executable instructions or a computer program product stored on one or more computer-readable storage media and executed on a computing device (e.g., a mobile phone or any other computing hardware). Computer readable storage media include tangible media accessible within a computing environment, such as optical media (DVD, CD), volatile memory (DRAM, SRAM), or nonvolatile memory (flash memory, hard drives). The term does not include signals, carrier waves, or communication connections.

The disclosure is not limited to the specific embodiments described. Conditional language such as “can,” “could,” “might,” or “may” is intended to indicate optional features, not requirements.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A system for predictive warranty claims detection in a multi-station assembly process, comprising:
a plurality of sensors disposed at multiple assembly stations and configured to generate sensor data indicative of assembly parameters for individual products;
a network configured to receive and store data in association with product identifiers and assembly station identifiers;
a computing device in communication with the network, the computing device comprising at least one processor and a memory storing instructions that, when executed by the processor, cause the computing device to:
provide the sensor data as sequential input to a trained deep learning neural network;
analyze the sensor data to detect deviations from normal sensor readings indicative of early defect patterns;
generate, before completion of a given product, an output indicative of a likelihood that the given product will lead to a warranty claim; and
output a notification when the likelihood satisfies a defect-risk criterion.

2. The system of claim 1, wherein the sensors are configured to continuously capture torque data, temperature data, and alignment data at each assembly station and stream torque data, temperature data, and alignment data in real time to the computing device.

3. The system of claim 1, wherein the computing device is further configured to identify complex fault patterns comprising combinations of deviations in sensor readings at different assembly stations that are associated with defects occurring in later assembly stages.

4. The system of claim 1, wherein the computing device is further configured to flag, as an early defect indicator, a combined condition including a misalignment at a first assembly station and a torque deviation at a second assembly station.

5. The system of claim 1, wherein the computing device is further configured to dynamically adjust at least one tolerance limit associated with the plurality of sensors jointly based on historical sensor data and historical warranty claim outcomes.

6. The system of claim 5, wherein dynamically adjusting the at least one tolerance limit comprises modifying a threshold used to determine whether a sensor deviation is treated as a potential defect indication.

7. The system of claim 1, wherein the notification is provided via a user interface to enable at least one of inspection and adjustment of at least one assembly operation for the given product before the given product leaves an associated assembly plant.

8. The system of claim 1, wherein the computing device is configured to perform transfer learning by initializing at least one predictive warranty claims module using parameters of a deep learning neural network trained on historical multi-station sensor data and warranty outcomes of a baseline product.

9. A system for detecting cross-station interactions that contribute to defects in a multi-station final assembly process, comprising:
a plurality of sensors disposed at different assembly stations and configured to generate sensor data for individual products;
a network configured to store the sensor data in association with product identifiers and assembly station identifiers;
a computing device configured to execute a trained deep learning neural network that produces predictions related to defect occurrence based on the sensor data; and
a cross-station interaction detection module implemented by the computing device;
wherein the cross-station interaction detection module is configured to apply rule-extraction techniques to the trained deep learning neural network; and generate one or more human-readable rules that relate combinations of sensor deviations at different assembly stations to probabilities of defects in the products.

10. The system of claim 9, wherein the one or more human-readable rules describe combinations of parameters across different assembly stations that are most likely to cause defects in a final assembly stage.

11. The system of claim 9, wherein at least one of the one or more human-readable rules specifies that a deviation in torque at a first assembly station and a temperature fluctuation at a second assembly station are associated with a predicted defect at a third assembly station.

12. The system of claim 9, wherein the cross-station interaction detection module is configured to identify dependencies between assembly stations that create conditions for defects and to output data indicative of such dependencies.

13. The system of claim 9, wherein the cross-station interaction detection module is further configured to determine, from the one or more human-readable rules, which assembly stations and sensors should be adjusted to reduce inter-station interactions that lead to defects.

14. The system of claim 9, further comprising a user interface configured to display the one or more human-readable rules with corresponding sensor data to show how activities at different assembly stations affect defect occurrence.

15. The system of claim 14, wherein the user interface is further configured to display, in real time, indications of cross-station interactions detected by the cross-station interaction detection module for products currently being assembled.

16. The system of claim 9, wherein the computing device is configured to determine an upper tolerance limit and a lower tolerance limit to detect a warranty claim for all sensor of the plurality of sensors concurrently.

17. A method for enhancing industrial final assembly quality by integrating predictive warranty claims detection with cross-station interaction analysis, the method comprising:
receiving, via a plurality of sensors disposed at a plurality of assembly stations sensor data indicative of assembly parameters for individual products;
storing, via a network, the sensor data in association with product identifiers and assembly station identifiers;
analyzing, by a computing device via a predictive warranty claims module, sequential sensor data using a deep learning neural network to detect early defect indicators;
determining, before completion of a given product, a likelihood that the given product will lead to a warranty claim;
applying, by the computing device via a cross-station interaction detection module, rule-extraction techniques to the deep learning neural network to generate human-readable rules identifying combinations of sensor deviations of the plurality of assembly stations that contribute to defects; and
providing, via at least one user interface, real-time alerts and visual indications of both predicted warranty-risk levels for individual products and critical cross-station interactions, to support modification of at least one of assembly operations and sensor tolerance limits.

18. The method of claim 17, further comprising:
training, via the computing device, a baseline classification model using a training dataset comprising the one or more features of the plurality of sensors and labels indicative of warranty-related outcomes;
computing, via the computing device, a baseline score for the baseline classification model; and
iteratively removing, via the computing device, one or more features of the plurality of sensors from the training dataset, retraining the baseline classification model, computing a corresponding score for each removal, and identifying as important features of the one or more features whose removal causes the score to at least one of decrease and fail to improve relative to the baseline score.

19. The method of claim 18, further comprising:
normalizing, via the computing device, positive score contributions of the important features determined from the score changes so that their contributions sum to a predetermined total, rank the important features according to their normalized contributions; and
selecting, via the computing device, a subset of the important features by cumulatively adding ranked features until a contribution threshold is met.

20. The method of claim 19, further comprising:
training, via the computing device, at least one of the predictive warranty claims module and the cross-station interaction detection module using the subset of the important features resulting in a model having an improved score relative to a model trained using all the one or more features.
